(19) United States
(12) Patent Application Publication
(10) Pub. No.: US 2014/0354591 A1
(43) Pub. Date: Dec. 4, 2014

(54) TOUCH PANEL

(71) Applicant: Wintek Corporation, Taichung City (TW)

(72) Inventors: Kuan-Yu Chu, Taichung City (TW); Yu-Ching Wang, Taichung City (TW); Chin-Pei Hwang, Taichung City (TW); Ming-Wu Chen, Nantou County (TW); Shih-Yun Chuang, New Taipei City (TW); Yuan-Kang Tseng, Taichung City (TW)

(73) Assignee: Wintek Corporation, Taichung City (TW)

(21) Appl. No.: 14/290,990

(22) Filed: May 30, 2014

(30) Foreign Application Priority Data
May 30, 2013 (TW) 102119200

(51) Int. Cl. G06F 3/046

(52) U.S. Cl. CPC G06F 3/046
USPC 345/174

(57) ABSTRACT

A touch panel includes a substrate, a patterned decoration layer, a patterned transparent conductive layer and an optical compensation layer. The patterned decoration layer is disposed on the substrate so as to define an opening region and a hole on the substrate. The hole is disposed adjacently to a side of the opening region. The patterned transparent conductive layer is disposed on the substrate. The patterned transparent conductive layer includes a transparent conductive pattern. The transparent conductive pattern is disposed correspondingly to the hole, and the transparent conductive pattern completely covers the hole along a vertical projective direction perpendicular to the substrate. The optical compensation layer is disposed on the substrate, and the optical compensation layer covers the hole along the vertical projective direction.

### BACKGROUND OF THE INVENTION

1. Field of the Invention

The present invention generally relates to a touch panel, and more particularly, to a touch panel including a transparent conductive pattern and an optical compensation layer disposed on a camera hole.

2. Description of the Prior Art

Touch sensing technologies are well-developed in recent years. Many consumer electronics, such as mobile phones and tablet PCs, are integrated with touch sensing functions. These consumer electronics are also integrated with the camera function generally. Accordingly, a corresponding camera hole has to be disposed on a cover glass of a touch panel, and a camera unit may then receive outside light through the camera hole. Improvement in the light transmission ratio of the camera hole may be an approach to enhance the photo quality of the camera unit. Traditionally, an attached anti-reflection film is used to enhance the light transmission ratio. However, because the camera hole is generally pretty small (with diameter around 1.5 mm), it is not easy to attach the anti-reflection film on the camera hole. Accordingly, the related manufacturing time will be longer, and the manufacturing cost and yield will be influenced.

### SUMMARY OF THE INVENTION

It is one of the objectives of the present invention to provide a touch panel. A transparent conductive pattern and an optical compensation layer are collocated on a hole of the touch panel so as to enhance the light transmission ratio of the hole.

To achieve the purposes described above, a preferred embodiment of the present invention provides a touch panel. The touch panel includes a substrate, a patterned decoration layer, a patterned transparent conductive layer and an optical compensation layer. The patterned decoration layer is disposed on the substrate so as to define an opening region and a hole on the substrate. The hole is disposed adjacently to a side of the opening region. The patterned transparent conductive layer is disposed on the substrate. The patterned transparent conductive layer includes a transparent conductive pattern. The transparent conductive pattern is disposed correspondingly to the hole, and the transparent conductive pattern completely covers the hole along a vertical projective direction perpendicular to the substrate. The optical compensation layer is disposed on the substrate, and the optical compensation layer covers the hole along the vertical projective direction.

In another embodiment of the present invention, the patterned transparent conductive layer further includes a plurality of touch electrodes disposed in the opening region.

In another embodiment of the present invention, the optical compensation layer further covers the opening region along the vertical projective direction.

In the present invention, the transparent conductive pattern disposed on the hole and the touch electrodes maybe made of identical material and formed at the same manufacturing step. Accordingly, the light transmission ratio of the hole in the touch panel of the present invention maybe enhanced without additional processes. In addition, the optical compensation layer disposed on the hole may also extend to cover the touch electrodes in the opening region so as to lower the visibility of the touch electrodes at the same time.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a touch panel according to a first preferred embodiment of the present invention.

FIG. 2 is a schematic cross-sectional diagram taken along a line A-A′ in FIG. 1.

FIG. 3 is a schematic diagram illustrating a touch panel according to a second preferred embodiment of the present invention.

FIG. 4 is a schematic diagram illustrating a touch panel according to a third preferred embodiment of the present invention.

FIG. 5 is a schematic diagram illustrating a touch panel according to a fourth preferred embodiment of the present invention.

FIG. 6 is a schematic diagram illustrating touch electrodes according to a preferred embodiment of the present invention.

FIG. 7 is a schematic diagram illustrating touch electrodes according to another preferred embodiment of the present invention.

FIG. 8 is a schematic diagram illustrating touch electrodes according to further another preferred embodiment of the present invention.

FIG. 9 is a schematic diagram illustrating a touch panel according to a fifth preferred embodiment of the present invention.

### DETAILED DESCRIPTION

To provide a better understanding of the present invention to the skilled users in the technology of the present invention, preferred embodiments will be detailed as follows. The preferred embodiments of the present invention are illustrated in the accompanying drawings with numbered elements to elaborate the contents and effects to be achieved.

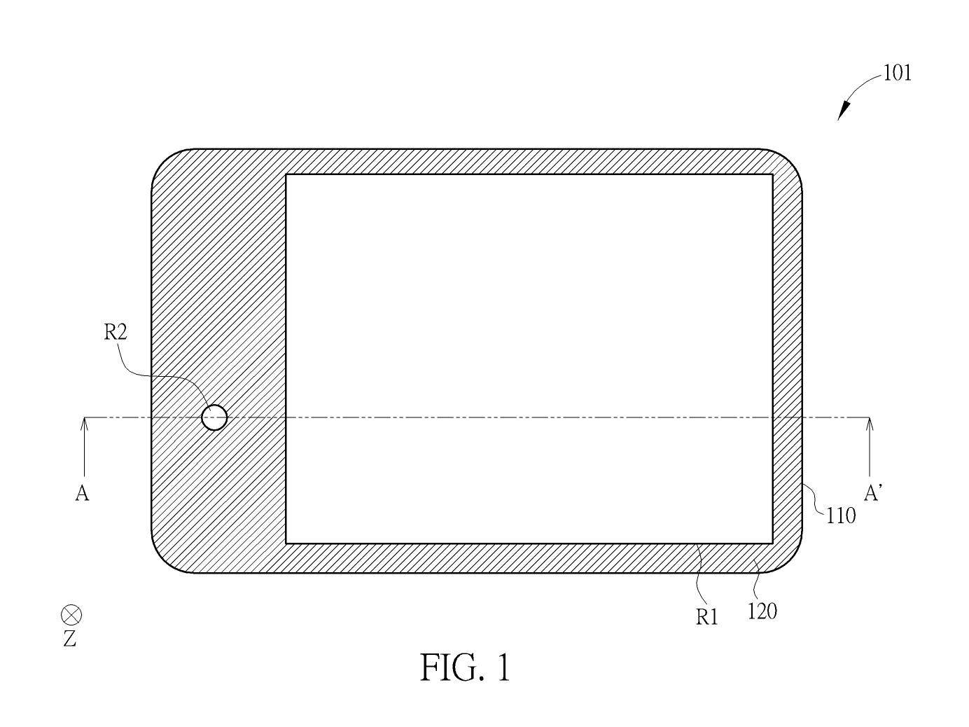

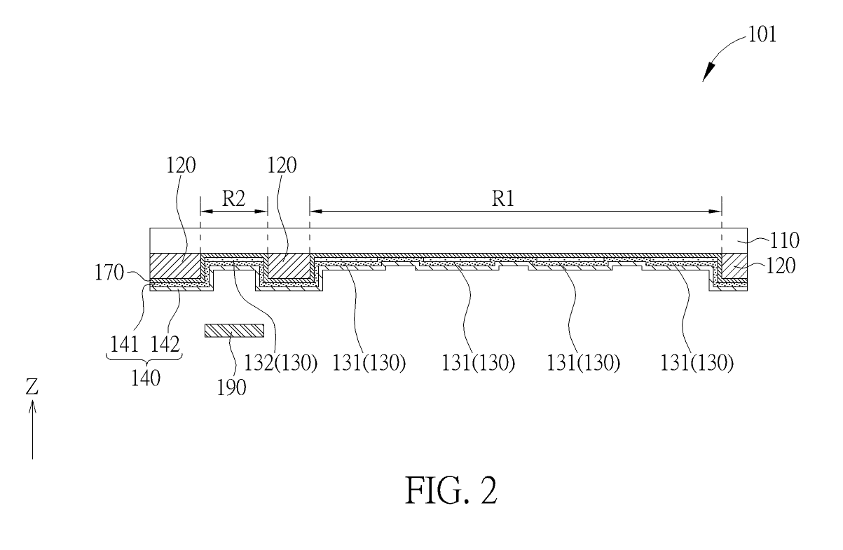

Please refer to FIG. 1 and FIG. 2. FIG. 1 is a schematic diagram illustrating a touch panel according to a first preferred embodiment of the present invention. FIG. 2 is a schematic cross-sectional diagram taken along a line A-A′ in FIG. 1. Please note that the figures are only for illustration and the figures may not be to scale. The scale may be further modified according to different design considerations. As shown in FIG. 1 and FIG. 2, the first preferred embodiment of the present invention provides a touch panel 101. The touch panel 101 includes a substrate 110, a patterned decoration layer 120, a patterned transparent conductive layer 130 and an optical compensation layer 140. The substrate 110 may include a glass substrate, a ceramic substrate, a plastic substrate or substrates made of other appropriate materials. The patterned decoration layer 120 is disposed on the substrate 110 so as to define an opening region R1 and a hole R2 on the substrate 110. The hole R1 is disposed adjacently to a side of the opening region 1. It is worth noting that the touch panel 101 in this embodiment may further include a light sensing device 190 disposed correspondingly to the hole R2. The light sensing device 190 may be an image capturing device, such as a camera, and the hole R2 may be an image capturing hole, such as a camera hole, but the present invention is not limited to this. In other preferred embodiments of the present invention, other light sensing devices, such as an optical near field sensing device, may be used as the light sensing device 190 corresponding to the hole R2. Additionally, an area of the opening region R1 is much larger than an area of the hole R2, and the shape of the hole R2 maybe adjustable according to different design considerations. The patterned transparent conductive layer 130 is disposed on the substrate 110. The patterned transparent conductive layer 130 includes a transparent conductive pattern 132. The transparent conductive pattern 132 is disposed correspondingly to the hole R2, and the transparent conductive pattern 132 completely covers the hole R2 along a vertical projective direction Z perpendicular to the substrate 110. The optical compensation layer 140 is disposed on the substrate 110, and the optical compensation layer 140 completely covers the hole R2 along the vertical direction Z. The patterned transparent conductive layer 130 may further include a plurality of touch electrodes 131, and the touch electrodes 131 are disposed in the opening region R1. The optical compensation layer 140 may further cover the opening region R1 along the vertical projective direction Z.

In this embodiment, the patterned transparent conductive layer 130 may include indium tin oxide (ITO), indium zinc oxide (IZO), aluminium zinc oxide (AZO) or other appropriate transparent conductive materials. The transparent conductive pattern 132 disposed on the hole R2 and the touch electrodes 131 are preferably made of identical material and formed at the same manufacturing step. It is worth noting that the transparent conductive pattern 132 may be connected to the touch electrodes 131 or not, according to different considerations. When the transparent conductive pattern 132 is electrically insulated from the touch electrodes 131, the transparent conductive pattern 132 is an electrically floating pattern preferably, but not limited thereto. In this embodiment, the patterned transparent conductive layer 130 is disposed between the substrate 110 and the optical compensation layer 140. The optical compensation layer 140 may preferably include a first compensation layer 141 and a second compensation layer 142 disposed in a stack configuration along the vertical projective direction Z, and the first compensation layer 141 is disposed between the patterned transparent conductive layer 130 and the second compensation layer 142, but not limited thereto. In other preferred embodiments of the present invention, a single layer optical compensation layer 140 or other kinds of multiple layered optical compensation layer 140 may be used to generate required optical compensation effects. In this embodiment, a refractive index of the first compensation layer 141 is preferably lower than a refractive index of the patterned transparent conductive layer 130 and a refractive index of the second compensation layer 142. The refractive index of the patterned transparent conductive layer 130 is preferably higher than a refractive index of the substrate 110. The first compensation layer 141 and the second compensation layer 142 may preferably include transparent insulation materials, such as silicon nitride, silicon oxide, silicon oxynitride, acrylic resin or other appropriate organic or inorganic transparent insulation materials. The light transmission ratio of the hole R2 may be enhanced by the allocation of the layers described above and the arrangement of their refraction indexes.

Please refer to Table 1 and FIG. 2. The improvement on the light transmission ratio and light reflection ratio of the hole R2 in this embodiment and the results of comparison samples, which are made of only a single glass substrate and a glass substrate with only silicon oxide layer and silicon nitride layer disposed on, are listed in Table 1, wherein the substrate 110 is a glass substrate having a refractive index around 1.5, the transparent conductive pattern is made of indium tin oxide having a refractive index around 1.9, the first compensation layer 141 is made of silicon oxide having a refractive index around 1.5, the second compensation layer 142 is made of silicon nitride having a refractive index around 1.87.

TABLE 1

| | Light transmission | Light reflection |
|---|---|---|
| | ratio (%) | ratio (%) |
| Glass substrate | 91.83 | 8.17 |
| Glass | 89.94 | 10.06 |
| substrate/SiO₂/SiNₓ | | |
| Glass | 92.97 | 6.20 |
| substrate/ITO/SiO₂/SiNₓ | | |

As shown in Table 1, compared to the light transmission ratio and the light reflection ratio of the samples of a single glass substrate and a glass substrate with only silicon oxide layer and silicon nitride layer disposed on, the light transmission ratio of the hole R2 in the touch panel of the present invention may be effectively enhanced by the allocation of the layers described above and the arrangement of their refraction indexes, and the light reflection ratio of the hole R2 in this embodiment may also be lowered. The light receiving condition of the light sensing device 190 may be improved accordingly.

In the present invention, the transparent conductive pattern 132 disposed on the hole R2 and the touch electrodes 131 are preferably made of identical material and formed at the same manufacturing step, and the light transmission ratio of the hole R2 maybe enhanced without additional process steps. On the other hand, apart from the improvement on the light transmission ratio of the hole R2 by the arrangement of the refractive index of each layer described above, the optical compensation layer 140 disposed on the hole R2 may further extend to cover the touch electrodes 131 in the opening region R1 so as to lower the visibility of the touch electrodes 131 and make it difficult to distinguish the touch electrodes 131. The visual quality of the touch panel maybe accordingly enhanced. In addition, the touch panel 101 may further include a strengthening layer 170 disposed between the patterned transparent conductive layer 130 and the substrate 110 for improving the ability of impact resistance of the substrate 110 and protecting the touch panel 101. The material of strengthening layer 170 may include an organic material, an inorganic material or a mixture of organic material and inorganic material. The organic material mentioned above may include a transparent organic material such as a polyurethane (PU) material, a polyimide (PI) material, an epoxy material, phenolic resin material, a polyester material, a silicone rubber material (such as polyisoprene rubber), a silicon material, rubber material or an organic mixture of the materials mentioned above. The inorganic material mentioned above may include titanium oxide (TiO₂) , silicon oxide (SiO₂), silicon nitride (SiNx), silicon oxynitride (SiOxNy) or other appropriate inorganic materials. The mixture of organic material and inorganic material mentioned above may include an acrylic material mixed with silica particles or aluminum oxide (Al₂O₃) particles. The mixture of the organic material and the inorganic material may have chemical bonding or not. For example, the strengthening layer 170 may include a thermosetting resin or a light-cured resin, such as positive photoresist or negative photoresist.

The following description will detail the different embodiments of the present invention. To simplify the description, identical components in each of the following embodiments are marked with identical symbols. For making it easier to understand the differences between the embodiments, the following description will detail the dissimilarities among different embodiments and the identical features will not be redundantly described.

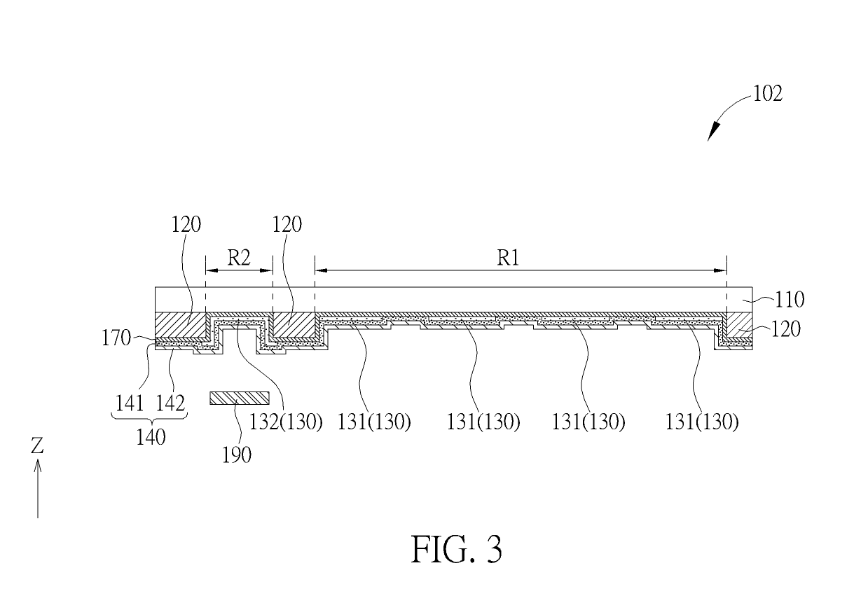

Please refer to FIG. 3. FIG. 3 is a schematic diagram illustrating a touch panel 102 according to a second preferred embodiment of the present invention. As shown in FIG. 3, the difference between the touch panel 102 in this embodiment and the touch panel in the first preferred embodiment is that, in the touch panel 102, the transparent conductive pattern 132 completely covers the hole R2 along the vertical projective direction Z, and the transparent conductive pattern 132 also partially covers the patterned decoration layer 120 around the hole R2 so as to keep the transparent conductive pattern 132 from being shifted by alignment process variations and ensure that the transparent conductive pattern 132 completely covers the hole R2.

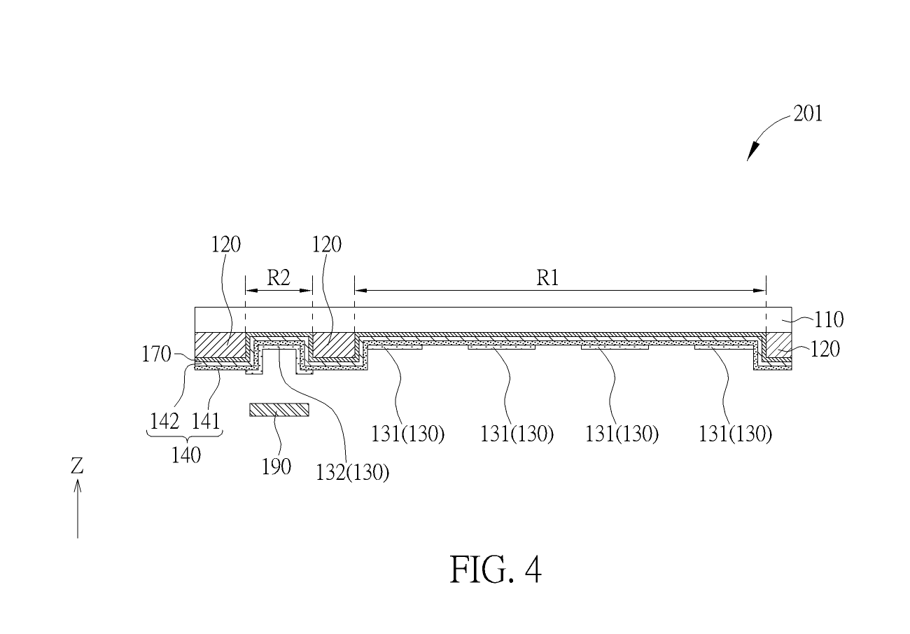

Please refer to FIG. 4. FIG. 4 is a schematic diagram illustrating a touch panel 201 according to a third preferred embodiment of the present invention. As shown in FIG. 4, the difference between the touch panel 201 in this embodiment and the touch panel in the first preferred embodiment is that, in the touch panel 201, the optical compensation layer 140 is disposed between the substrate 110 and the patterned transparent conductive layer 130, and the second compensation layer 142 is disposed between the substrate 110 and the first compensation layer 141. The refractive index of the second compensation layer 142 is higher than the refractive index of the first compensation layer 141 and the refractive index of the substrate 110. The refractive index of the patterned transparent conductive layer 130 is higher than the refractive index of the first compensation layer 141. Apart from the disposition sequence of the layers in the touch panel 201, the material properties of each component in this embodiment are similar to those of the first preferred embodiment and will not be redundantly described. In addition, the touch panel 201 may also include the strengthening layer 170 disposed between the optical compensation layer 140 and the substrate 110 for improving the ability of impact resistance of the substrate 110 and protecting the touch panel 201. The strengthening layer 170 is also disposed between the second compensation layer 142 and the substrate 110.

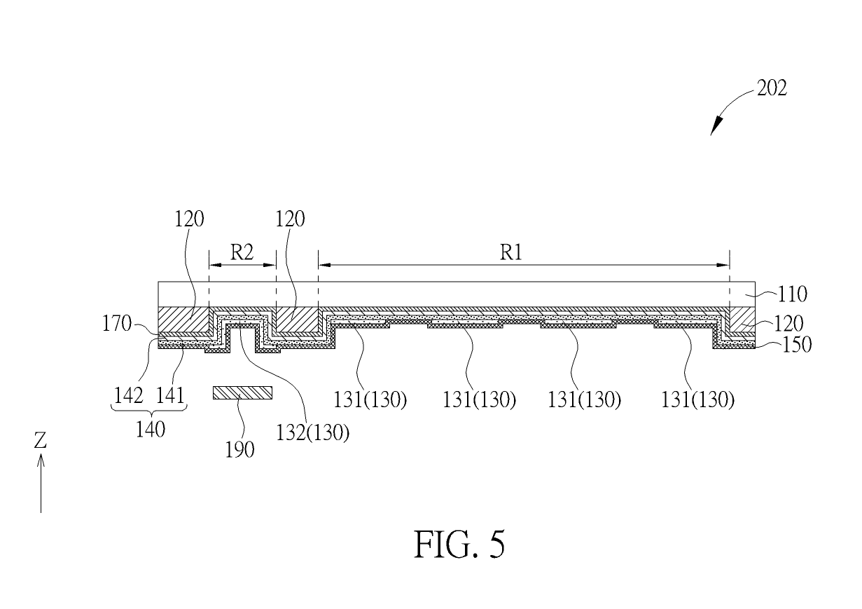

Please refer to FIG. 5. FIG. 5 is a schematic diagram illustrating a touch panel 202 according to a fourth preferred embodiment of the present invention. As shown in FIG. 5, the difference between the touch panel 202 in this embodiment and the touch panel in the third preferred embodiment is that, the touch panel 202 further includes a third compensation layer 150 disposed on the substrate 110 and covering the hole R2 and the opening region R1. The patterned transparent conductive layer 130 is disposed between the first compensation layer 141 and the third compensation layer 150. The refractive index of the patterned transparent conductive layer 130 is higher than a refractive index of the third compensation layer 150 and the refractive index of the first compensation layer 141. The third compensation layer 150 may preferably include transparent insulation materials, such as acrylic resin or other appropriate organic or inorganic transparent insulation materials.

In the above embodiments, the patterned transparent conductive layer is disposed between the substrate and the optical compensation layer, or the optical compensation layer is disposed between the substrate and the patterned transparent conductive layer, but the present invention is not limited to this. In other embodiments of the present inventions, an optical compensation layer may also be disposed between the substrate and the patterned transparent conductive layer including the touch electrodes while another optical compensation layer is disposed on the patterned transparent conductive layer including the touch electrodes. Each of the optical compensation layers may be a single layer structure or a multiple layered structure so as to lower the visibility of the touch electrodes and improve the visual effect of the touch panel. The design of the optical compensation layer disposed on the patterned transparent conductive layer may be referred to the contents of the first preferred embodiment or the second preferred embodiment. The design of the optical compensation layer disposed between the substrate and the patterned transparent conductive layer may be referred to the contents of the third preferred embodiment or the fourth preferred embodiment. Additionally, the strengthening layer 170 may also be disposed between the optical compensation layer and the substrate for improving the ability of impact resistance of the substrate and protecting the touch panel.

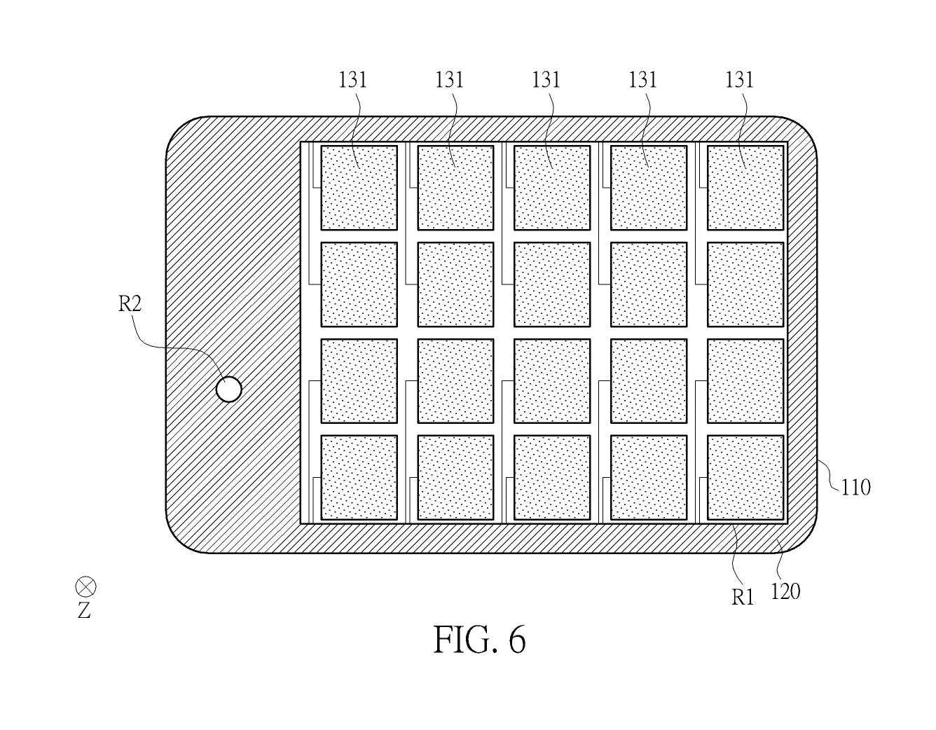

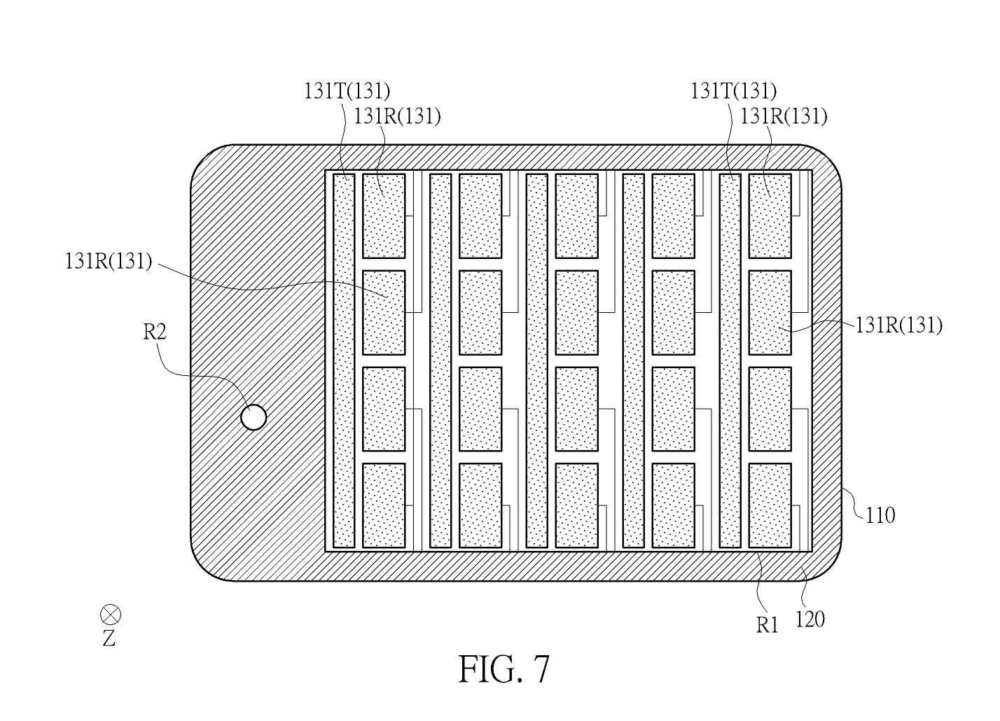

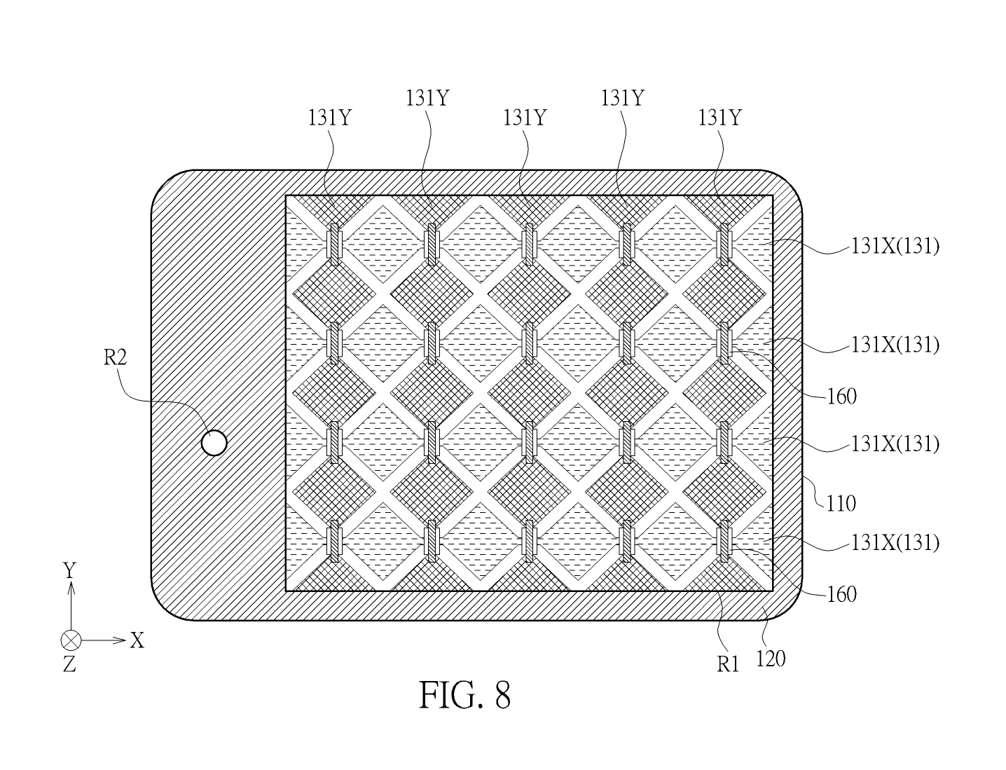

Please refer to FIG. 6, FIG. 7 and FIG. 8. FIG. 6 is a schematic diagram illustrating touch electrodes according to a preferred embodiment of the present invention. FIG. 7 is a schematic diagram illustrating touch electrodes according to another preferred embodiment of the present invention. FIG. 8 is a schematic diagram illustrating touch electrodes according to further another preferred embodiment of the present invention. As shown in FIG. 6, the touch electrodes 131 in the embodiments described above may be electrodes electrically insulated from one another so as to execute a self capacitive type touch sensing operation, but not limited thereto. The shape of each touch electrode 131 may be a rectangle, a triangle or other appropriate shapes. Additionally, as shown in FIG. 7, the touch electrodes 131 in the embodiments described above may also include a plurality of touch signal receiving electrodes 131R and a plurality of touch signal transmitting electrodes 131T disposed alternately in the opening region R1 so as to execute a mutual capacitive type touch sensing operation, but not limited thereto. In addition, as shown in FIG. 8, the touch electrodes 131 in the embodiments described above may also include a plurality of first axis electrodes 131X extending along a first direction X. The first axis electrodes 131X may cross a plurality of second axis electrodes 131Y extending along a second direction Y so as to execute the self capacitive type touch sensing operation or the mutual capacitive type touch sensing operation. The first direction X is preferably perpendicular to the second direction Y, but not limited thereto. The first axis electrodes 131X are electrically insulated from the second axis electrodes 131Y. An insulation island 160 or an insulation layer (not shown) may be disposed at regions that the first axis electrodes 131X cross the second axis electrodes 131Y, but not limited thereto. It is worth noting that the touch electrodes 131 of the touch panel in the present invention are not limited to the conditions described in FIGS. 6-8 and may be further modified according to other design considerations.

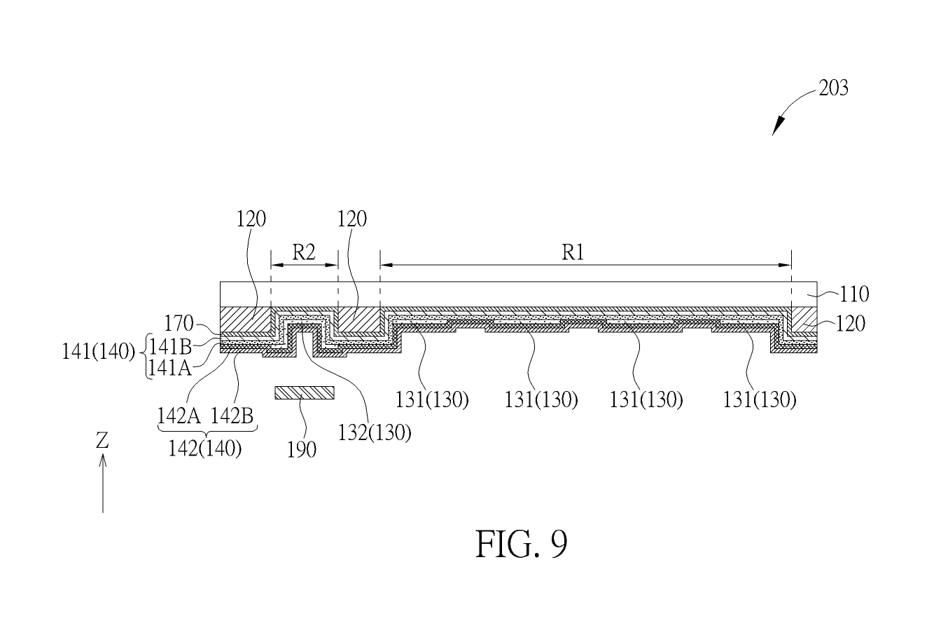

Please refer to FIG. 9. FIG. 9 is a schematic diagram illustrating a touch panel 203 according to a fifth preferred embodiment of the present invention. As shown in FIG. 9, the difference between the touch panel 203 in this embodiment and the touch panel in the first preferred embodiment is that, in the touch panel 203, the optical compensation layer 140 includes a first compensation layer 141 and a second compensation layer 142. The first compensation layer 141 is disposed between the substrate 110 and the patterned transparent conductive layer 130, and the patterned transparent conductive layer 130 is disposed between the first compensation layer 141 and the second compensation layer 142. Additionally, the first compensation layer 141 may include a first sub-layer 141A and a second sub-layer 141B stacked along the vertical projective direction Z. The second sub-layer 141B is disposed between the first sub-layer 141A and the substrate 110. A refractive index of the second sub-layer 141B is higher than a refractive index of the substrate 110 and a refractive index of the first sub-layer 141A. The second compensation layer 142 may include a third sub-layer 142A and a fourth sub-layer 142B stacked along the vertical projective direction Z. The third sub-layer 142A is disposed between the patterned transparent conductive layer 130 and the fourth sub-layer 142B. A refractive index of the third sub-layer 142A is lower than a refractive index of the patterned transparent conductive layer 130 and a refractive index of the fourth sub-layer 142B. The refractive index of the patterned transparent conductive layer 130 is higher than the refractive index of the first sub-layer 141A preferably, and the refractive index of the patterned transparent conductive layer 130 is higher than the refractive index of the substrate 110 preferably, but not limited thereto. The refractive index allocation mentioned above may be used to lower the visibility of the touch electrodes and improve the visual effect of the touch panel. In addition, the touch panel 203 may also include the strengthening layer 170 disposed between the first compensation layer 141 and the substrate 110 for improving the ability of impact resistance of the substrate 110 and protecting the touch panel 203.

To summarize the above descriptions, in the touch panel of the present invention, the transparent conductive pattern and the optical compensation layer are collocated on the camera hole so as to enhance the light transmission ratio of the camera hole. In the present invention, the transparent conductive pattern disposed on the hole and the touch electrodes may be made of identical material and formed at the same manufacturing step. The light transmission ratio of the hole in the touch panel of the present invention may be enhanced without additional processes accordingly. In addition, the optical compensation layer disposed on the hole may also extend to cover the touch electrodes in the opening region so as to lower the visibility of the touch electrodes at the same time. The visual quality of the touch panel may be enhanced accordingly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch panel, comprising:
a substrate;
a patterned decoration layer, disposed on the substrate so as to define an opening region and a hole on the substrate;
a patterned transparent conductive layer, disposed on the substrate, wherein the patterned transparent conductive layer comprises a transparent conductive pattern disposed correspondingly to the hole, and the transparent conductive pattern completely covers the hole along a vertical projective direction perpendicular to the substrate; and
an optical compensation layer, disposed on the substrate, wherein the optical compensation layer covers the hole along the vertical projective direction.

2. The touch panel of claim 1, wherein the patterned transparent conductive layer further comprises a plurality of touch electrodes disposed in the opening region.

3. The touch panel of claim 1, wherein the optical compensation layer further covers the opening region.

4. The touch panel of claim 2, wherein the transparent conductive pattern is electrically insulated from the touch electrodes, and the transparent conductive pattern is an electrically floating pattern.

5. The touch panel of claim 2, wherein the transparent conductive pattern is electrically connected to the touch electrodes.

6. The touch panel of claim 1, further comprising a light sensing device disposed correspondingly to the hole.

7. The touch panel of claim 6, wherein the light sensing device is an image capturing device, and the hole is an image capturing hole.

8. The touch panel of claim 1, wherein the patterned transparent conductive layer is disposed between the substrate and the optical compensation layer.

9. The touch panel of claim 8, further comprising a strengthening layer, disposed between the patterned transparent conductive layer and the substrate.

10. The touch panel of claim 8, wherein a refractive index of the pattern transparent conductive layer is higher than a refractive index of the substrate.

11. The touch panel of claim 10, wherein the optical compensation layer comprises a first compensation layer and a second compensation layer disposed in a stack configuration along the vertical projective direction, the first compensation layer is disposed between the patterned transparent conductive layer and the second compensation layer, and a refractive index of the first compensation layer is lower than a refractive index of the second compensation layer and the refractive index of the patterned transparent conductive layer.

12. The touch panel of claim 11, further comprising a strengthening layer disposed between the patterned transparent conductive layer and the substrate.

13. The touch panel of claim 1, wherein the optical compensation layer is disposed between the substrate and the pattern transparent conductive layer.

14. The touch panel of claim 13, further comprising a strengthening layer disposed between the optical compensation layer and the substrate.

15. The touch panel of claim 13, wherein the optical compensation layer comprises a first compensation layer and a second compensation layer disposed in a stack configuration along the vertical projective direction, the second compensation layer is disposed between the substrate and the first compensation layer, and a refractive index of the second compensation layer is higher than a refractive index of the first compensation layer and a refractive index of the substrate.

16. The touch panel of claim 15, wherein a refractive index of the patterned transparent conductive layer is higher than the refractive index of the first compensation layer.

17. The touch panel of claim 16, further comprising a strengthening layer disposed between the second compensation layer and the substrate.

18. The touch panel of claim 16, further comprising a third compensation layer, disposed on the substrate and covering the hole and the opening region, wherein the patterned transparent conductive layer is disposed between the first compensation layer and the third compensation layer, and the refractive index of the patterned transparent conductive layer is higher than a refractive index of the third compensation layer.

19. The touch panel of claim 18, further comprising a strengthening layer disposed between the second compensation layer and the substrate.

20. The touch panel of claim 1, wherein the optical compensation layer comprises a first compensation layer and a second compensation layer, the first compensation layer is disposed between the substrate and the patterned transparent conductive layer, and the patterned transparent conductive layer is disposed between the first compensation layer and the second compensation layer.

21. The touch panel of claim 20, wherein the first compensation layer comprises a first sub-layer and a second sub-layer stacked along the vertical projective direction, the second sub-layer is disposed between the first sub-layer and the substrate, and a refractive index of the second sub-layer is higher than a refractive index of the substrate and a refractive index of the first sub-layer.

22. The touch panel of claim 21, wherein a refractive index of the patterned transparent conductive layer is higher than the refractive index of the first sub-layer.

23. The touch panel of claim 20, wherein a refractive index of the patterned transparent conductive layer is higher than a refractive index of the substrate.

24. The touch panel of claim 23, wherein the second compensation layer comprises a third sub-layer and a fourth sub-layer stacked along the vertical projective direction, the third sub-layer is disposed between the patterned transparent conductive layer and the fourth sub-layer, and a refractive index of the third sub-layer is lower than the refractive index of the patterned transparent conductive layer and a refractive index of the fourth sub-layer.

25. The touch panel of claim 20, further comprising a strengthening layer disposed between the first compensation layer and the substrate.
